(19) United States
(12) Patent Application Publication
(10) Pub. No.: US 2010/0110893 A1
(43) Pub. Date: May 6, 2010

(54) SYSTEM AND METHOD FOR PROVIDING USER FEEDBACK IN ASSOCIATION WITH CONTENT IN A NETWORK

(75) Inventor: Younghyun Lee, Seoul (KR)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/268,149

(22) Filed: Nov. 10, 2008

(30) Foreign Application Priority Data
Nov. 3, 2008 (KR) 10-2008-108323

(51) Int. Cl. H04L 12/26

(52) U.S. Cl. 370/241

(57) ABSTRACT

Methods and apparatus are described for enabling users to provide feedback in relation to content. Such a method includes receiving a stamp registration request from a first client terminal, wherein the stamp registration request includes first content identification information for identifying a first content item and first stamp information representing first user feedback relating to the first content item. The first stamp information identifies a first visual stamp object and a first stamp location representing a position of the first visual stamp object relative to a visual representation of the first content item in a user interface. Embodiments of the invention also include registering the first stamp information in association with the first content identification information and providing the first stamp information to a second client terminal in conjunction with responding to a content request from the second client terminal identifying the first content item.

### BACKGROUND OF THE INVENTION

The present invention relates to systems and methods for enabling users to provide and review feedback relating to content in a network.

With regard to content provided in a network, there have been widely used comment mechanisms by which a user consuming the content may add his or her opinion to the content. When content is provided to a user, some mechanism is often provided with which the user may enter text and register his or her opinion for the content. The system then constructs and provides a list of opinions that have been registered in this way. However, in such a system, users typically have to write their opinions in text which requires considerable time and effort. In addition, users also have to expend considerable time and effort to read the previously registered opinions of other users one by one. Therefore, even if a user feels inclined to express his or her opinion for particular content, the time and effort required is a disincentive to participation. On the other hand, if there is provided only a very simple mechanism for expressing opinions, e.g., a binary voting system for and against the content, then the users' opinions become indistinguishable from each other, presenting another disincentive for the users to express their opinions.

Accordingly, there is a considerable significance for mechanisms that can provide users with motivation to express their opinions regarding content on a network in a convenient as well as characteristic manner.

It should also be noted that there is currently a considerable amount of content available on networks for which no mechanism for providing an opinion is provided. For example, a plain image file which may be accessed by a URI (universal resource identifier) in a format that looks like “http://img.yahoo.co.kr/ . . . /yhlogo2.gif” is not typically provided with an associated opinion expression mechanism. In another example, when a variety of information is presented in a single screen, e.g., a main page of a portal service, an opinion expression mechanism is generally not provided.

Accordingly, there is a considerable significance for mechanisms that allow users to express their opinions for such content.

### SUMMARY OF THE INVENTION

According to the present invention, systems and methods are provided which enable users to provide feedback regarding content provided in a network. In accordance with an embodiment of the present invention, there is provided a method for enabling users to provide feedback in relation to content, including: receiving a stamp registration request from a first client terminal, wherein the stamp registration request includes first content identification information for identifying a first content item and first stamp information representing first user feedback relating to the first content item, and wherein the first stamp information identifies a first visual stamp object and a first stamp location representing a position of the first visual stamp object relative to a visual representation of the first content item in a user interface; registering the first stamp information in association with the first content identification information; and providing the first stamp information to a second client terminal in conjunction with responding to a content request from the second client terminal identifying the first content item.

In accordance with another embodiment of the present invention, there is provided a method for enabling a first user associated with a first client terminal to provide feedback regarding a first item of content, including: obtaining the first item of content and generating a visual representation thereof in a user interface associated with the first client terminal; generating first stamp information for the first content item, wherein the first stamp information represents first user feedback relating to the first content item, and identifies a first visual stamp object and a first stamp location representing a position of the first visual stamp object relative to the visual representation of the first content item in the user interface; and transmitting a stamp registration request message to a remote device, wherein the stamp registration request message includes first content identification information for identifying the first content item and the first stamp information.

In accordance with another embodiment of the present invention, there is provided a method for presenting user feedback in conjunction with presenting a visual representation of a first content item, including: receiving a request for the user feedback relating to the first content item from a first client terminal; retrieving first stamp information from a database, wherein the first stamp information represents the user feedback relating to the first content item and identifies one or more visual stamp objects and one or more stamp locations representing positions of the one or more visual stamp objects relative to the visual representation of the first content item; and transmitting the first stamp information to the first client terminal.

In accordance with another embodiment of the present invention, there is provided a method for presenting user feedback in conjunction with presenting a visual representation of a first content item, including: transmitting a request for the user feedback relating to the first content item; receiving first stamp information representing the user feedback, wherein the first stamp information identifies one or more visual stamp objects and one or more stamp locations representing positions of the one or more visual stamp objects relative to the visual representation of the first content item; and presenting the one or more visual stamp objects in conjunction with the visual representation of the first content in accordance with the received first stamp information.

In accordance with another embodiment of the present invention, there is provided a method for identifying content having a first visual stamp object associated therewith, including: receiving a request for content having the first visual stamp object associated therewith, wherein the first visual stamp object represents user feedback relating to a content item and is presented in relation to a visual representation of the content item in a user interface; retrieving content identification information for a first plurality of content items with which the first visual stamp object is associated; and providing the content identification information in response to the request.

In accordance with another embodiment of the present invention, there is provided a method for identifying content having a first visual stamp object associated therewith, including: transmitting a request for content having the first visual stamp object associated therewith, wherein the first visual stamp object represents user feedback relating to a content item and is presented in relation to a visual representation of the content item in a user interface; receiving content identification information for a first plurality of content items with which the first visual stamp object is associated; and presenting the content identification information.

In accordance with another embodiment of the present invention, there is provided a computer readable medium having computer program instructions recorded therein, wherein the computer program instructions are configured to cause a computer to execute any of the foregoing methods.

In accordance with another embodiment of the present invention, there is provided a computer readable medium with a plurality of data structures recorded therein, each data structure including: content identification data identifying a corresponding content item; and stamp data representing user feedback relating to the corresponding content item and identifying one or more visual stamp objects and one or more stamp locations representing positions of the one or more visual stamp objects relative to a visual representation of the corresponding content item in a user interface.

A further understanding of the nature and advantages of the present invention may be realized by reference to the remaining portions of the specification and the drawings.

### BRIEF DESCRIPTION OF THE DRAWINGS

FIG. 1 shows a simplified representation of a computing environment in which embodiments of the present invention may be implemented.

FIG. 2 shows a configuration of a client terminal which may be used to implement embodiments of the present invention.

FIG. 3 shows a configuration of the function module 216 in accordance with one embodiment of the present invention.

FIG. 4 shows a functional block diagram of the server system 120 in accordance with one embodiment of the present invention.

FIG. 5 shows one embodiment of a method implemented in accordance with the invention.

FIGS. 6 and 7 show display screens to illustratively describe embodiments of a stamping method implemented in accordance with the invention.

FIG. 8 shows another embodiment of a method implemented in accordance with the invention.

FIG. 9 shows one embodiment of a method for retrieving a content list for a particular stamp shape implemented in accordance with the invention.

FIG. 10 shows a display screen to illustratively describe embodiments of a method for retrieving a content list implemented in accordance with the invention.

FIG. 11 shows another embodiment of a method for retrieving a content list for a particular stamp shape implemented in accordance with the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

As mentioned above, various embodiments of the invention provide mechanisms by which users may provide feedback regarding content provided in a network such as, for example, the Web. According to a particular class of embodiments, such feedback is enabled through the use of “stamps” which are embodied as visual objects in a graphical user interface which may represent or in some way be associated with content about which users wish to express an opinion. These stamps are a digital analog of the use of rubber stamps and colored ink pads to provide feedback or commentary on paper documents.

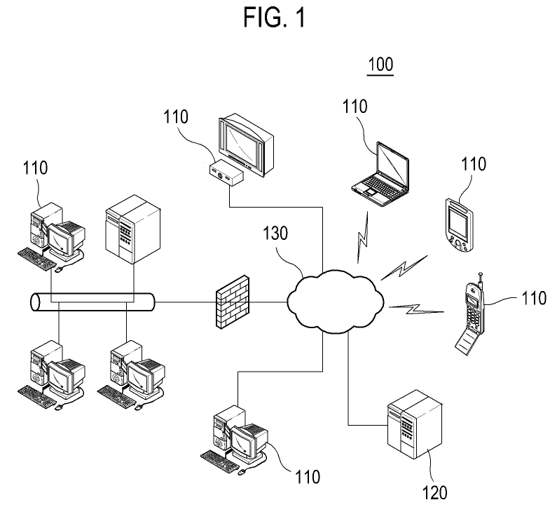

FIG. 1 shows a simplified configuration of a computing environment in which embodiments of the present invention may be implemented. Referring to FIG. 1, a network system 100 includes client terminals 110 and a server system 120. The client terminals 110 may include any type of computers (e.g., desktop, laptop, tablet, etc.), media computing platforms (e.g., cable, satellite set top boxes, digital video recorders, etc.), handheld computing devices (e.g., PDAs, email clients, etc.), cell phones, or any other type of computing or communication platforms. The server system 120 may include a server device or decentralized server devices, and may include mainframe computers, mini computers, super computers, personal computers or combinations thereof. Further, although FIG. 1 illustrates only one server system 120, a plurality of server systems 120 may also be used, without departing from the scope of the present invention. The client terminals 110 and the server system 120 may communicate with each other through a network 130. The network 130 may comprise, e.g., wired networks such as LAN (local area network), WAN (wide area network), MAN (metropolitan area network), ISDN (Intergrated Service Digital Network), etc., and wireless networks such as wireless LAN, CDMA, Bluetooth, satellite communication, etc., without limiting the present invention.

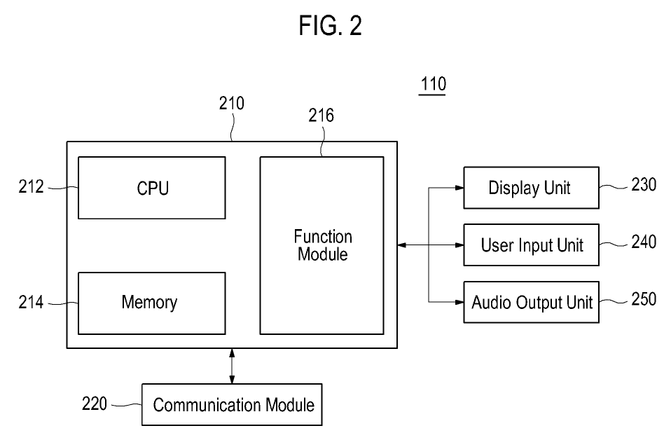

FIG. 2 shows a configuration of a client terminal in accordance with one embodiment of the present invention. Referring to FIG. 2, the client terminal 110 includes a computing platform 210 that can accommodate and execute software application programs, and a communication module 220 that includes hardware and software for communication through the network 130. The computing platform 210 generally includes a CPU (central processing unit) 212 that may include, for example, microprocessors, digital signal processors (DSPs) and/or microcontrollers, and a memory 214 that may include volatile and/or nonvolatile memories. The computing platform 210 interacts with various input/output devices. The computing platform 210 may also include a function module 216 to support desired functions. The function module 216 may include hardware and/or software, and may share the hardware and/or software with other function modules (not shown), as necessary or appropriate. Although FIG. 2 shows the function module 216 separated from other elements, the function module 216 need not be physically separated. For example, the function module 216 may be embodied as a software program stored in the memory 214. The function module 216 may exchange data with other function modules or even cooperate with them. The client terminal 110 may also include user interfaces to provide information to and receive inputs from users, which may include a display unit 230 such as computer monitors, a user input unit 240 such as a keyboard or a mouse, and an audio output unit 250 such as speakers, etc.

The memory 214 may include, e.g., a Read Only Memory (ROM), EPROM (Erasable and Programmable ROM) and/or EEPROM (Electrically EPROM), etc. In addition, the memory 214 may be mounted in a detachable manner to allow replacement or upgrades as necessary or appropriate. That is, the memory 214 may also include other types of storage devices such as a SmartMedia® card, a CompactFlash® card, a Memory Stick®, a MultiMediaCard®, a DataPlay disc®, and/or a SecureDigital® card, etc.

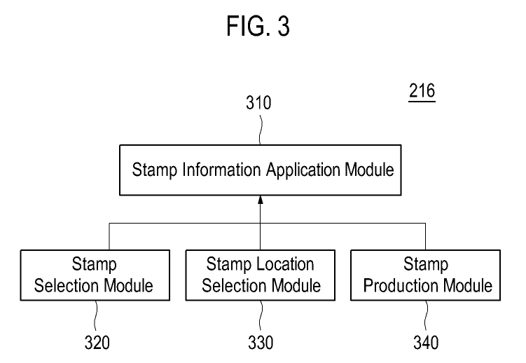

FIG. 3 shows a configuration of the function module 216 in accordance with one embodiment of the present invention. Referring to FIG. 3, the function module 216 may include a stamp information application module 310 to process stamp information (such as to exchange the stamp information with a server system through the communication module 220), a stamp selection module 320 to provide users with a function to select a visual stamp object (e.g., a particular stamp shape), and a stamp location selection module 330 to provide the users with a function to select a stamp location. The stamp selection module 320 and the stamp location selection module 330 may allow a user to place a new stamp on particular content. The function module 216 may further include a stamp production module 340 to allow users to produce or modify their own visual stamp objects. The stamp selection module 320 and the stamp location selection module 330 may be implemented in a variety of technologies and forms, such as, for example, ActiveX of Microsoft Corporation, Flash of Adobe Systems Inc., JavaScript, AJAX (asynchronous javascript and xml), web browser add-ons, standalone application programs, etc., without liming the present invention.

In one embodiment, the stamp information application module 310 may include a function of constructing a request message to request information on previously registered stamps, and a function of extracting the information on the registered stamps from a response message. The stamp information application module 310 may further include a function of receiving information (such as the shape and the location) of a new stamp from the stamp selection module 320 and the stamp location selection module 330, and constructing a stamp registration request message to request registration of the information on the new stamp. Furthermore, the stamp information application module 310 may also include a function of constructing a request message to request a content list associated with a particular visual stamp object. In order to support such functions, the stamp information application module 310 may be configured to process requests and responses using, for example, the HTTP protocol. Alternatively or additionally, the stamp information application module 310 may also be configured to use the HTTPS protocol, the FTP protocol, or any other applicable protocols to process the requests and responses, all of which are included in the present invention.

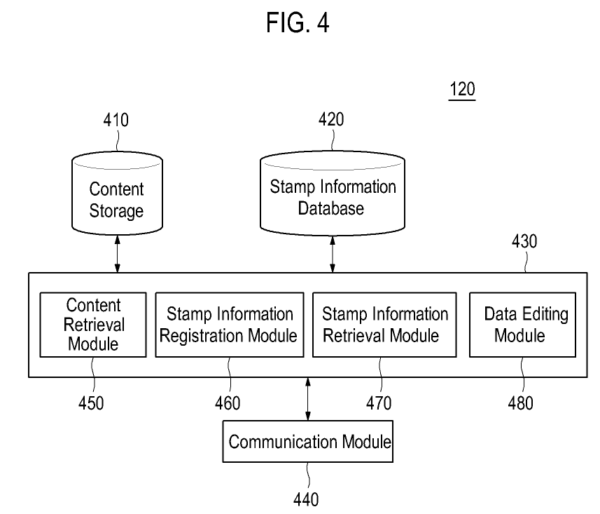

FIG. 4 shows a functional block diagram of the server system 120 in accordance with one embodiment of the present invention. Referring to FIG. 4, the server system 120 includes a content storage 410, a stamp information database 420, a function module 430, and a communication module 440 configured to provide a communication interface with the network 130.

The content storage 410 is configured to store a variety of content that may be provided in response to requests from the users. The content may include text information and/or non-text information such as, for example, text (e.g., HTML documents, plain text, Microsoft Word files, wiki documents, etc.), images (e.g., bitmap files, GIF files, TIFF files, etc.), photographs (e.g., JPEG files, etc.), sounds (e.g., wave files, MP3 files, OGG files, WMA files, etc.), moving images (e.g., MPEG files, AVI files, WMV files, etc.), or combinations of these information types, without limiting the present invention.

The stamp information database 420 is configured to store information linking the various pieces of content and registered stamps. In one embodiment, each record in the stamp information database 420 may be configured to store information for identifying particular content, and information on a stamp that has been stamped on or associated with the particular content. For example, the stamp information database 420 may be a RDB (relational database) including a table having the fields of <URI of content, identifier of a visual stamp object, horizontal coordinate of a stamp location, vertical coordinate of the stamp location>. In addition, the stamp information database 420 may be configured to further include various other types of information as necessary or appropriate. For example, a table in the stamp information database 420 may be configured to further include a registration time of the stamp, information to identify the user who created, registered, and/or placed the stamp.

In one embodiment, the function module 430 includes a content retrieval module 450, a stamp information registration module 460, and a stamp information retrieval module 470. The content retrieval module 450 may be configured to communicate with the content storage 410 to retrieve desired content, and to transmit the retrieved content using the communication module 440.

The stamp information registration module 460 may be configured to register information on a new stamp for particular content, in the stamp information database 420. The items included in the new stamp information may relate to the structure of the stamp information database 420. For example, in case the stamp information database 420 includes a table having the fields of <URI of content, identifier of a visual stamp object, horizontal coordinate of a stamp location, vertical coordinate of the stamp location>, the new stamp information may similarly include the URI of content, the identifier of a visual stamp object, the horizontal coordinate of a stamp location, and the vertical coordinate of the stamp location. However, it would be appreciated by those skilled in the art that the new stamp information of the present invention is not limited thereto.

In one embodiment, the stamp information retrieval module 470 may be configured to communicate with the stamp information database 420 to retrieve information on the stamps registered for particular content. For example, in case the stamp information database 420 includes a table having the fields of <URI of content, identifier of a visual stamp object, horizontal coordinate of a stamp location, vertical coordinate of the stamp location>, the stamp information retrieval module 470 may be configured to transmit a query to the stamp information database 420 with the URI of content as a select condition, and receive, as a result, a set of records in the form of <identifier of a visual stamp object, horizontal coordinate of a stamp location, vertical coordinate of the stamp location>.

The above description refers to an embodiment in which the stamp information retrieval module 470 transmits a query to the stamp information database 420 with the URI of particular content as a select condition, to thereby retrieve information on the stamps registered for that content. However, embodiments of the invention are contemplated in which the stamp information retrieval module 470 may be configured to, additionally or alternatively, perform other types of retrieval. For example, the stamp information retrieval module 470 may be configured to retrieve a content list for a particular visual stamp object. To be more specific, in one embodiment, the stamp information retrieval module 470 may transmit a query to the stamp information database 420 with the visual stamp object identifier as a select condition, to thereby retrieve information on a plurality of content items for which the stamp of the corresponding shape is registered.

In one embodiment, the function module 430 may further include a data editing module 480 configured to edit and provide the content retrieved by the content retrieval module 450 and/or the stamp information retrieved by the stamp information retrieval module 470. In one embodiment, the data editing module 480 may perform a function of merging the content retrieved by the content retrieval module 450 and the stamp information retrieved by the stamp information retrieval module 470, so that the content and the stamp information may be included in a single response message. For example, in case the retrieved content is an HTML document, the data editing module 480 may be configured to modify the HTML document so that the stamps registered for the content are arranged on a separate overlay distinguishable from the content. In this case, the overlay on which the stamps are arranged may be configured to be hidden by default and be displayed in response to a predetermined event (such as a user's mouse click on a specific location or interface object) by using, for example, technologies such as JavaScript. It would be appreciated by those skilled in the art that any of a variety of techniques to merge the content and the stamp information can be employed without departing from the scope of the present invention. Note that it is not mandatory in the present invention to merge the content and the stamp information.

Additionally or alternatively, the data editing module 480 may include various other editing functions. For example, with respect to retrieval of a content list for a particular visual stamp object, when the stamp information retrieval module 470 extracts information on a plurality of content items for which the stamp of the corresponding shape is registered from the stamp information database 420, the data editing module 480 may be configured to make a list of the content items and to perform various editing operations such as, for example, hyperlink insertion or page division, as necessary or appropriate.

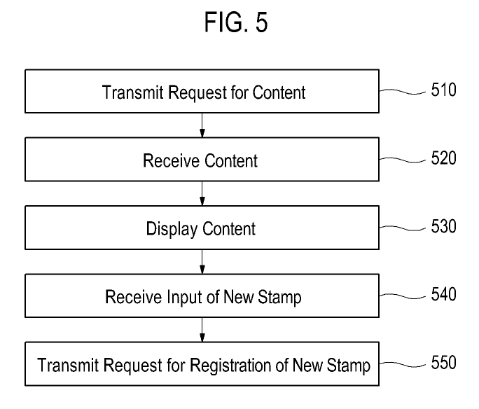

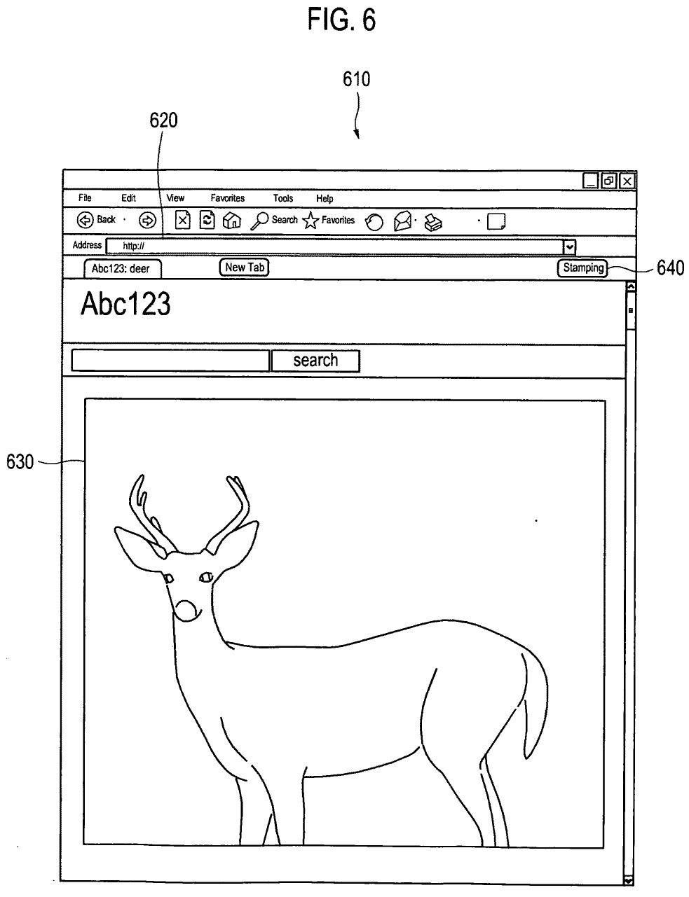

FIG. 5 illustrates the operation of one embodiment of the invention from the perspective of a client terminal. Referring to FIG. 5, the client terminal transmits a request for particular content to a server system (step 510). Referring to FIGS. 1 and 2, when a user of the client terminal 110 selects the desired content by the user input unit 240, the computing platform 210 constructs a request message (e.g., an HTTP request message) to request the selected content, and uses the communication module 220 to transmit the constructed request message to the server system 120 through the network 130. Referring to FIG. 6, the user may select the content by, for example, inputting the URI of the desired content in an address bar 620 of a web browser interface 610.

Referring back to FIG. 5, as a response to the transmitted request message, the client terminal 110 receives the corresponding content from the server system 120 (step 520). The receipt of the content from the server system 120 may be accomplished by, for example, receiving an HTTP response message that includes the content. In this case, the computing platform 210 of the client terminal 110 may be configured to analyze the received HTTP response message to extract the content. Note that the content may be obtained from other sources than the server system 120, without departing from the scope of the present invention.

In one embodiment, the client terminal 110 may also receive information identifying one or more stamps that have been previously registered in association with the content. Such a stamp look-up allows a user to take a look at the stamps that have been previously registered for the content by other users, and to refer to the opinion expressions of other users who have read or otherwise experienced the content before. The client terminal 110 may receive the registered stamp information by, for example, receiving, as a response to the content request of step 510, the information on the stamps previously registered for the content together with the content itself from the server system 120. In another example, the client terminal 110 may transmit another request, separately from the content request of step 510, to the server system 120 to retrieve the information on the stamps registered for the content, and receive the previously registered stamp information from the server system 120 as a response to the separate request. This separate request for retrieval of the registered stamp information may be made almost concurrently with the request for the content, or may be made in response to a predetermined event such as the user's mouse click on a specific location or object in the user's interface. In one embodiment, the registered stamp information may include all of the stamps previously registered in association with the content. However, in other embodiments, the registered stamp information may include only a subset of the stamps selected on the basis of, for example, registration time (e.g., using a predetermined time window, etc.), user IDs (e.g., a blacklist, a contact list of a user who requested the information, etc.) or other applicable methods, all of which are included in the present invention.

Upon receipt of the content from the server system 120 at step 520, the client terminal 110 displays the received content to the user (step 530). For example, referring to FIG. 6, the received content 630 may be displayed in a web browser interface 610.

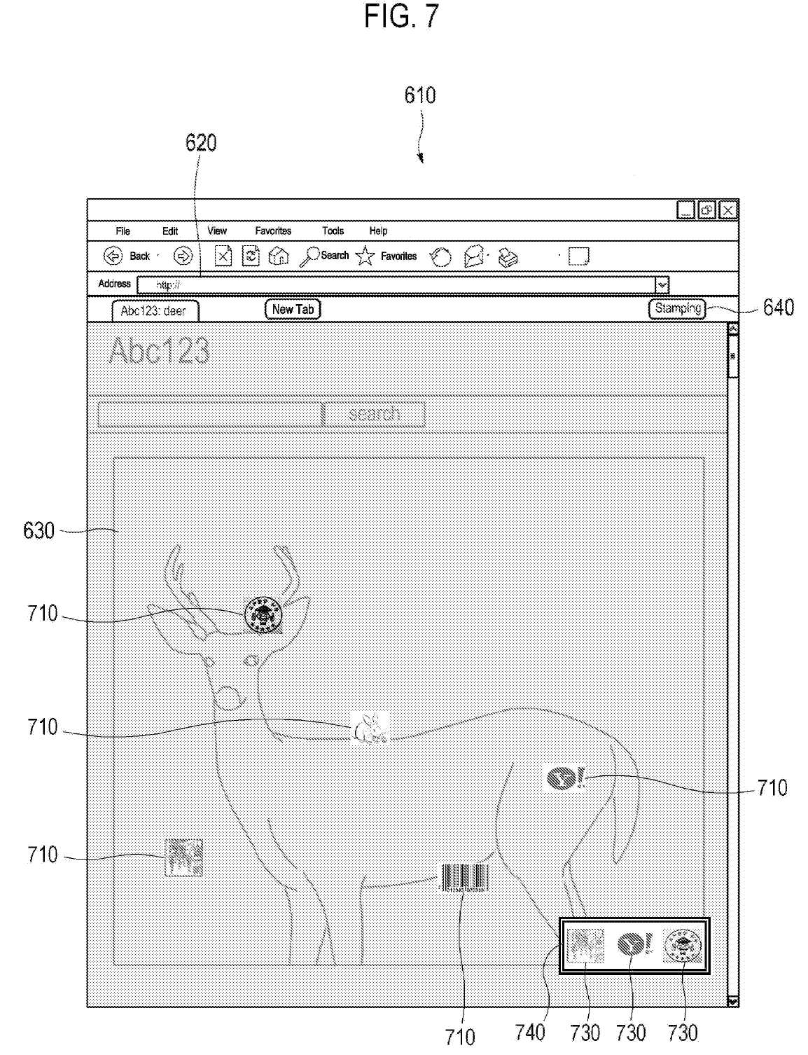

In one embodiment, when the information on the stamps registered for the content 630 is received, the registered stamp information may be displayed to the user together with the content 630 at step 530. In another embodiment, the registered stamp information received from the server system 120 may be hidden by default and be displayed in response to a predetermined event such as the user's mouse click on a specific location or object in the user's interface. For example, as shown in FIG. 6, only the content 630 is displayed in the web browser interface 610 by default with the registered stamp information hidden. Then, an overlay 720 on which visual representations of registered stamps 710 are arranged may be displayed, as shown in FIG. 7. As mentioned above, overlay 720 may be presented in response to a predetermined event such as, for example, the user's mouse click on the button 640 located in a specific area of the web browser interface 610. In one embodiment, the overlay 720 may be displayed overlapping the content 630, and the overlay 720 may be transparent or semitransparent so that the registered stamps 710 may be shown together with the content 630 in a overlapping manner. However, the present invention is not limited thereto. Further, it is not mandatory in the present invention that the registered stamps 710 are displayed in response to a click on the button 640 as shown in FIG. 6. On the contrary, it would be appreciated by those skilled in the art that other types of generally applicable events (such as lapse of a predetermined time duration, movement of a mouse pointer onto a predetermined location, input of a predetermined keyboard command, etc.) may also be used to cause the display of the registered stamps 710. In some embodiments, the visual representation of the registered stamps 710 may be associated with several additional functionalities. For example, in case a registered stamp 710 accompanies accessory information (e.g., a supplementary comment, a short audio file, etc.) as will be described later, the accessory information may be provided when a mouse pointer moves onto the visual representation of the corresponding registered stamp 710. In another example, the visual representation may be configured so that a user's click on a registered stamp 710 may invoke a menu including function items associated with the corresponding registered stamp 710. The function items may enable a user, for example, to request a content list for the visual stamp object of the registered stamp 710, to send a short message to the registrant of the registered stamp 710, to request a chat with the registrant of the registered stamp 710, to add the registrant of the registered stamp 710 in a blacklist, etc. The above has been provided only for illustrative purposes and those skilled in the art may associate various other functionalities with the visual representation of the registered stamps 710 without departing from the scope of the present invention.

Referring back to FIG. 5, the client terminal 110 receives a user's input of a new stamp on the displayed content 630 (step 540), based on which new stamp information is generated. For example, and referring to FIG. 3, the client terminal 110 may receive the new stamp input from the user by using the stamp selection module 320 and the stamp location selection module 330.

In one embodiment, the stamp selection module 320 may present the user with a plurality of characteristic visual stamp objects associated with the user, and receive input of a desired visual stamp object from the user through the user input unit 240 such as a mouse or a keyboard. For example, the plurality of characteristic visual stamp objects associated with the user may be transmitted from the server system 120 by a method not shown, detailed implementation of which may be accomplished using any of a variety of techniques well known to those skilled in the art. In another example, the plurality of characteristic visual stamp objects associated with the user may be temporarily or persistently stored in advance in, for example, the memory 214 of the client terminal 110. In the plurality of visual stamp objects, each visual stamp object may have a specific meaning. For example, one visual stamp object may mean recommendation, while another may mean disapproval, etc. The user may select a particular visual stamp object according to the substance, quality, preference, etc. of the content 630. For example, referring to FIG. 7, the stamp selection module 320 may display a stamp selection area 740 including icons 730 of the plurality of visual stamp objects associated with the user at the right bottom corner of the overlay 720 displayed in the web browser interface 610. The user may select a desired visual stamp object by various methods such as, for example, dragging or clicking the icon 730 of the desired visual stamp object from among the plurality of visual stamp object icons 730 displayed in the stamp selection area 740 using a mouse, by pressing a number key (e.g., “1”, “2”, etc.) corresponding to the order of the icon 730 of the desired visual stamp object, etc. In case only one stamp is stored in association with the user, the stamp selection module 320 may automatically assign the shape of the stamp as the selected visual stamp object. The above selection methods are provided only for an illustrative purpose, and those skilled in the art may employ a variety of other methods to allow the user to select the visual stamp object, without departing from the scope of the present invention.

Referring to FIGS. 2 and 3, the stamp location selection module 330 may receive input of the user's selection of a desired stamp location through the user input unit 240. Referring to FIG. 7, the stamp location selection module 330 may allow the user to select the desired location on the stamp overlay 720 overlapping the content 630 by the methods such as a mouse drop, a mouse click, etc. For example, in case the user selects the visual stamp object by dragging the icon 730 of the desired visual stamp object from the stamp selection area 740, the stamp location selection module 330 may receive the selection of the stamp location by detecting that the user drops the dragged visual stamp object icon 730 at the desired location, i.e., releases the mouse button after the mouse pointer has been moved onto the desired location. In another example, in case it is configured that the user may select the desired visual stamp object by the methods such as a mouse click or the like, the user may first click the mouse on the desired visual stamp object icon 730, move the mouse pointer to the desired location, and then click the mouse once more at the desired location, to thereby select the location on which the stamp is to be placed. The stamp location selection module 330 may detect the above operation to receive the user's selection of the stamp location. The foregoing examples are provided only for illustrative purposes, and it may be appreciated by those skilled in the art that the stamp location selection module 330 may receive the user's selection of the stamp location by various other methods without departing from the scope of the present invention.

In another embodiment, the user may be allowed to select the stamp location first, and then select the visual stamp object later. That is, referring to FIG. 7, in response to a location being selected, e.g., by the user's mouse click on the location on which the user wants to place the stamp in the stamp overlay 720, the stamp selection area 740 including the visual stamp object icons 730 may be displayed near the mouse pointer. Then, the user may select the desired visual stamp object icon 730 in the displayed stamp selection area 740.

The foregoing examples have described receiving the visual stamp object selection and the stamp location selection from the user. However, the present invention is not limited thereto, and various modifications and additional functionalities may be supported. For example, when a user places a new stamp for particular content, the user may be allowed, in addition to inputting the shape and the location of the new stamp, to input a supplementary comment for the new stamp, if desired. The user may also attach other accessory information, such as a short audio file, to the new stamp. In such an embodiment, it may be that the supplementary comment inputted by the user is shown as a tooltip in response to the mouse pointer's movement onto the stamp when the stamp is displayed in association with the content to another user. The short audio file attached to the stamp may also be reproduced in response to the mouse pointer's movement, In another example, the visual stamp object may include a graphical icon and/or a short message. In still another example, it may be that, even in case the visual stamp object has not been produced in advance, a user can produce and place a desired shape instantly, i.e., without leaving the web browser interface 610 as shown in FIG. 7. Further, embodiments are contemplated in which such an instantly produced visual stamp object may be additionally stored as a visual stamp object associated with the user.

Referring back to FIG. 5, the client terminal 110 requests registration of the new stamp inputted for the content by the user to the server system 120 (step 550). The registration request may be performed by, for example, transmitting a new stamp registration request message, which may include information for identifying the content 630, information on the selected visual stamp object (e.g., an identifier of the selected visual stamp object), and information on the selected stamp location (e.g., coordinates of the selected stamp location), to the server system 120. It would be appreciated by those skilled in the art that various other types of information may be additionally or alternatively included in the new stamp registration request message as necessary or appropriate. The new stamp registration request message may be constructed, for example, in an HTTP request message format. However, the present invention is not limited thereto. Rather various other protocols and formats may be used without departing from the scope of the present invention.

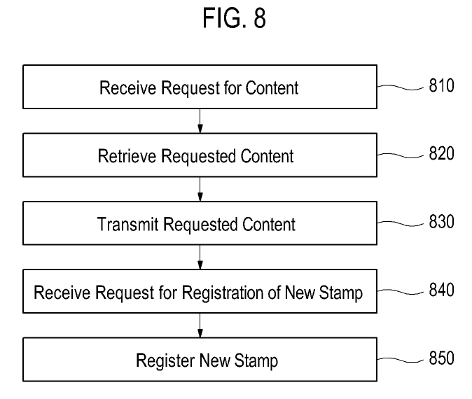

FIG. 8 illustrates operation of one embodiment of the present invention from the perspective of a server system. Referring to FIG. 8, a server system receives a request for particular content from a client terminal (step 810). Referring to FIGS. 1 and 4, the server system 120 may use the communication module 440 to receive a content request message from the client terminal 110 through the network 130. The content request message received by the communication module 440 may be delivered to the content retrieval module 450. In one embodiment, the content request message may be an HTTP request message including information for identifying the content (e.g., the URI of the content).

Referring back to FIG. 8, upon receiving the request for the content, the server system 120 retrieves the requested content (step 820). For example, referring to FIG. 4, the content retrieval module 450 may perform step 820 by using information on the requested content (e.g., a path information obtained by analyzing the URI of the content included in the HTTP request message) to retrieve the content from the content storage 410.

Referring back to FIG. 8, the server system 120 transmits the retrieved content to the client terminal 110 (step 830). For example, referring to FIG. 4, the content retrieval module 560 may perform step 830 by constructing an HTTP response message with the content retrieved from the content storage 410, and transmitting the HTTP response message through the communication module 440.

In one embodiment, the server system 120 may also provide information on the stamps that have been previously registered in association with the content, together with the retrieved content itself, to the client terminal 110. For example, referring to FIG. 4, the content identification information included in the content request message received at step 810 may be also provided to the stamp information retrieval module 470. The stamp information retrieval module 470 may transmit a SQL (structured query language) statement that instructs “select” to the stamp information database 420 with the URI of the content as a select condition, and as a result, may extract the registered stamp information (e.g., information on visual stamp objects and locations) out of the records that includes the URI of the content. In one embodiment, the stamp information retrieved by the stamp information retrieval module 470 may be merged with the content retrieved by the content retrieval module 450 into a single response by the data editing module 480, and then be provided to the client terminal 110. Although the stamp information retrieval module 470 may provide information on all of the stamps previously registered in association with the content, the stamp information retrieval module 470 may also limit the stamp information to identify only a subset of the stamps without departing from the scope of the claimed invention. For some examples, the stamp information retrieval module 470 may select only a predetermined number of most recently registered stamps, stamps registered within a predetermined time window, stamps registered by users in a user group (e.g., a contact list) defined with reference to a user who requested the stamp information or stamps registered by users not included in a blacklist, all of which are included in the present invention.

In another embodiment, the server system 120 may be configured to receive another request for retrieval of the registered stamp information separate from the request for the content from the client terminal 110 and, as a response to the separate retrieval request, to retrieve and provide the registered stamp information. Note that it does not matter even if the content originates from outside of the server system 120. The retrieval request for the registered stamp information may have the format of an HTTP request message including information to identify the content (e.g., the URI of the content). Further, the registered stamp information may be provided in the format of an HTTP response message. However, the present invention is not limited thereto.

Referring back to FIG. 8, the server system 120 receives a new stamp registration request from the client terminal 110 (step 840). In one embodiment, the new stamp registration request may include information for identifying the content on which the new stamp is to be placed (e.g., the URI of the content), as well as the information on the shape of the new stamp and the location where the new stamp is to be placed. Referring to FIG. 4, the new stamp registration request may be received by the communication module 440 and then be delivered to the stamp information registration module 460.

Referring back to FIG. 8, the server system 120 registers the new stamp information in association with the content identification information and/or the content itself (step 850). Referring to FIG. 4, upon receiving the new stamp registration request, the stamp information registration module 460 may communicate with the stamp information database 420 to store the information on the new stamp in a new record in the stamp information database 420. For example, the stamp information registration module 460 may construct an SQL statement to “insert” a record including the information on the new stamp, and transmit the SQL statement to the stamp information database 420.

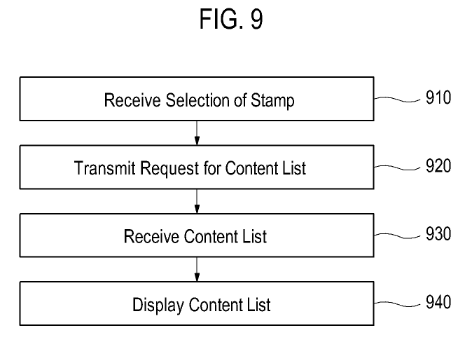

FIG. 9 illustrates operation of one embodiment of a method for retrieving a content list for a particular visual stamp object from the perspective of a client terminal. In the depicted embodiment, a user may select a particular visual stamp object to retrieve a list of content items on which the stamp has been registered. By this method, the user may, for example, easily search for and consume other content for which other users having similar taste have provided feedback. The user may also easily search and consume the content which the user himself/herself has previously consumed and placed the particular stamp on. Referring to FIG. 9, the client terminal receives a user's selection of a particular visual stamp object (step 910). Referring to FIG. 2, the client terminal 110 may use, for example, the stamp selection module 320 to receive the user's selection of the particular visual stamp object through the user input unit 240. For example, referring to FIG. 7, step 910 may be performed by detecting that, on the overlay 720 where the stamps 710 registered for particular content are displayed, the user selects the stamp 710 having the desired shape by a mouse click. In another example, step 910 may be performed by detecting that, after referring to the visual stamp objects associated with the user himself/herself or other users possibly in a screen (not shown) distinguished from the screen of FIG. 7, the user selects the desired visual stamp object among the visual stamp objects by a predetermined method (e.g., a mouse click on the icon representing the desired visual stamp object). The user's selection of a particular visual stamp object may be received at step 910 by any of a wide variety of methods, all of which are included within the scope of the present invention.

Referring back to FIG. 9, the client terminal 110 transmits to the server system 120 a request for a list of content items for the visual stamp object selected at step 910, or in other words, of the content items on which the stamp of the selected shape has been registered or placed (step 920). Referring to FIGS. 2 and 3, step 920 may be performed in such a manner that the stamp information application module 310 of the client terminal 110 receives the information on the selected visual stamp object from the stamp selection module 320, constructs an HTTP request message including the information on the selected visual stamp object, and transmits the HTTP request message to the server system 120 through the communication module 220.

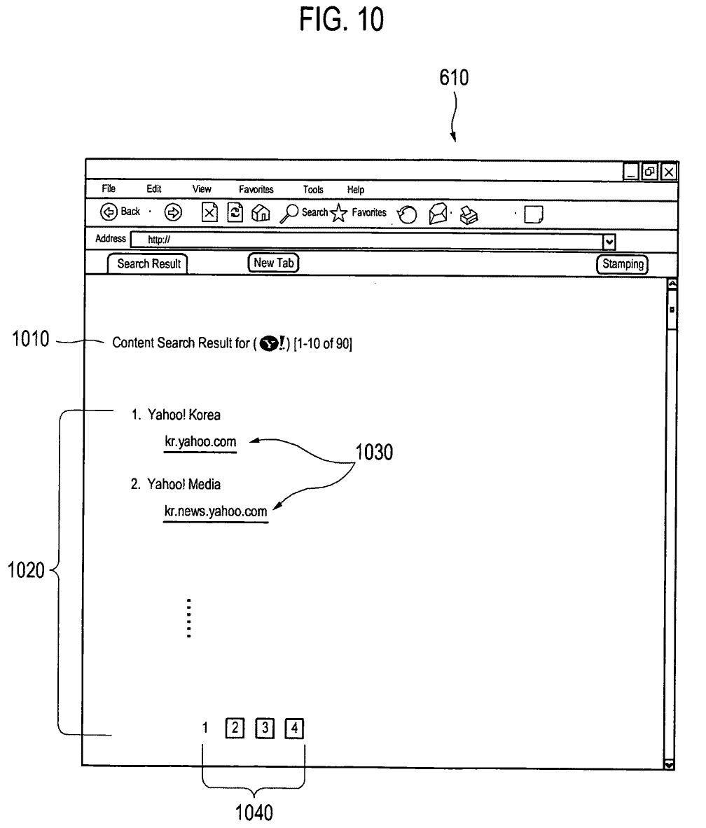

Referring back to FIG. 9, the client terminal 110 receives the content list requested at step 920 from the server system 120 (step 930), and displays the received content list to the user (step 940). In one embodiment, the content list may include URI-based hyperlinks to the content, and may also include various other kinds of information as necessary or appropriate. For example, referring to FIG. 10, there is shown an example screen when a stamp 1010 is selected, in which the web browser interface 610 displays a list 1020 of the content items on which the stamp 1010 has been placed or registered. The content list 1020 includes hyperlinks 1030 linked to the respective content items. When the user selects a hyperlink 1030 for a particular content item, the selected content may be received and displayed in the web browser interface 610 through a process as shown, for example, in steps 510 to 530 of FIG. 5. Referring back to FIG. 10, the list 1020 of all of the content on which the stamp 1010 has been placed need not be displayed in one screen. That is, the list 1020 may be displayed in several divided pages, e.g., with hyperlinks 1040 to other pages.

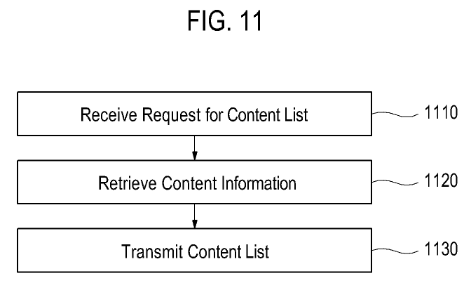

FIG. 11 illustrates operation of one embodiment of a method for retrieving a content list for a particular visual stamp object from the perspective of a server system. Referring to FIG. 11, the server system receives a request for a content list identifying content associated with a selected visual stamp object from a client terminal (step 1110). Referring to FIGS. 1 and 4, the communication module 440 of the server system 120 receives the content list retrieval request from the client terminal 110 through the network 130, and then delivers the content list retrieval request to the stamp information retrieval module 470.

Referring back to FIG. 11, the server system 120 retrieves information on the content associated with the selected visual stamp object (step 1120). Referring to FIG. 4, the stamp information retrieval module 470 may deliver an SQL statement instructing “select” to the stamp information database 420 with the identifier of the selected visual stamp object as a select condition and, as a result, may extract information on the content (e.g., the URIs of the content) on which the corresponding stamp has been placed or registered out of the records including the visual stamp object identifier. In case the stamp information database 420 includes additional information for the corresponding content (e.g., brief descriptions of the content), then the additional information may be extracted together with the URIs of the content. In one embodiment, additional information on the content may be obtained by referring to other storage or databases such as, for example, the content storage 410, with the URIs of the content extracted from the stamp information database 420.

Referring back to FIG. 11, the retrieved information on the content is constructed into a list and then transmitted to the client terminal 110 (step 1130). For example, referring to FIG. 4, the content information may be constructed into a list by the data editing module 480. In case the retrieved content information includes the URIs of the content, the data editing module 480 may edit and construct the content list so that the content list includes hyperlinks to the respective content items. Further, in case the content list includes more than a predetermined number of content items, the data editing module 480 may divide them into several pages, and provide the pages one by one according to requests from the client terminal 110.

The various aspects of the invention may be practiced in a wide variety of network environments including, for example, TCP/IP-based networks, telecommunications networks, wireless networks, etc. In addition, the computer program instructions and data structures with which embodiments of the invention are implemented may be stored in any type of tangible computer-readable media, and may be executed according to a variety of computing models including, for example, a client/server model, a peer-to-peer model, on a stand-alone computing device, or according to a distributed computing model in which various of the functionalities described herein may be effected or employed at different locations. The steps of the methods described herein need not be performed in the illustrated order, but may be adjusted, omitted and/or expanded without departing from the scope of the present invention.

In addition, the various functionalities described herein need not necessarily be divided among the various modules in the manner described. That is, particular modules have been described herein as being responsible for particular functionalities. It will be understood, however, that this has been done for illustrative purposes and should not be used to limit the scope of the invention. As will be understood, that various functionalities described herein may be distributed among devices, software modules, and one or more networks in a wide variety of ways without departing from the invention.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method for enabling users to provide feedback regarding content, comprising:
receiving a stamp registration request from a first client terminal, the stamp registration request including first content identification information for identifying a first content item and first stamp information representing first user feedback relating to the first content item, the first stamp information identifying a first visual stamp object and a first stamp location representing a position of the first visual stamp object relative to a visual representation of the first content item in a user interface;
registering the first stamp information in association with the first content identification information; and
providing the first stamp information to a second client terminal in conjunction with responding to a content request from the second client terminal identifying the first content item.

2. The method of claim 1 wherein the first stamp information includes a supplementary comment for presentation in conjunction with the first visual stamp object.

3. The method of claim 1 further comprising providing additional stamp information to the second client terminal in conjunction with responding to the content request, the additional stamp information corresponding to one or more additional visual stamp objects for presentation in conjunction with the visual representation of the first content item and the first visual stamp object.

4. The method of claim 3 wherein the additional stamp information represents second user feedback, and wherein the first user feedback and the second user feedback are provided by users in a user group defined with reference to a user who generated the content request.

5. The method of claim 1 further comprising providing additional content identification information to the second client terminal, the additional content identification information corresponding to one or more additional content items with which the first visual stamp object has been associated.

6. The method of claim 1 wherein the first visual stamp object identifies who provided the first user feedback.

7. A method for enabling a first user associated with a first client terminal to provide feedback regarding a first item of content, comprising:
obtaining the first item of content and generating a visual representation thereof in a user interface associated with the first client terminal;
generating first stamp information for the first content item, the first stamp information representing first user feedback relating to the first content item and identifying a first visual stamp object and a first stamp location representing a position of the first visual stamp object relative to the visual representation of the first content item in the user interface; and
transmitting a stamp registration request message to a remote device, the stamp registration request message including first content identification information for identifying the first content item, and the first stamp information.

8. The method of claim 7, wherein the generating includes:
receiving selection of the first stamp location from the first user.

9. The method of claim 8, wherein the receiving includes:
providing an overlay to overlap the visual representation of the first content item; and
receiving the selection of the first stamp location on the overlay.

10. The method of claim 7, wherein the generating includes:
receiving selection of the first visual stamp object from the first user among a plurality of visual stamp objects associated with the first user.

11. The method of claim 7, further comprising:
receiving second stamp information representing user feedback associated with the first content item from the remote device; and
generating a visual representation of the user feedback in conjunction with the first content item.

12. The method of claim 7, further comprising:
providing the first user with stamp production means that enable the first user to produce the first visual stamp object; and
receiving the first visual stamp object produced by the first user using the stamp production means.

13. A method for presenting user feedback in conjunction with presenting a visual representation of a first content item, comprising:
receiving a request for the user feedback relating to the first content item from a first client terminal;
retrieving first stamp information from a database, the first stamp information representing the user feedback relating to the first content item and identifying one or more visual stamp objects, and one or more stamp locations representing positions of the one or more visual stamp objects relative to the visual representation of the first content item; and
transmitting the first stamp information to the first client terminal.

14. The method of claim 13, further comprising filtering the user feedback at least in part based on users who registered the user feedback.

15. The method of claim 13, further comprising filtering the user feedback at least in part based on time when the user feedback was registered.

16. A method for presenting user feedback in conjunction with presenting a visual representation of a first content item, comprising:
transmitting a request for the user feedback relating to the first content item;
receiving first stamp information representing the user feedback, the first stamp information identifying one or more visual stamp objects and one or more stamp locations representing positions of the one or more visual stamp objects relative to the visual representation of the first content item; and
presenting the one or more visual stamp objects in conjunction with the visual representation of the first content item in accordance with the received first stamp information.

17. The method of claim 16, wherein the presenting includes:
providing the visual representation of the first content item; and
causing the one or more visual stamp objects to overlay the visual representation of the first content item.

18. The method of claim 17, wherein causing the one or more visual stamp objects to overlay the visual representation of the first content item includes:
detecting a predetermined event after providing the visual representation of the first content item; and
displaying the one or more visual stamp objects in response to detection of the predetermined event.

19. A method for identifying content having a first visual stamp object associated therewith, comprising:
receiving a request for content having the first visual stamp object associated therewith, the first visual stamp object representing user feedback relating to a content item and being presented in relation to a visual representation of the content item in a user interface;
retrieving content identification information for a first plurality of content items with which the first visual stamp object is associated; and
providing the content identification information in response to the request.

20. The method of claim 19, wherein the content identification information includes URIs (universal resource identifiers) of the first plurality of content items.

21. A method for identifying content having a first visual stamp object associated therewith, comprising:
transmitting a request for content having the first visual stamp object associated therewith, the first visual stamp object representing user feedback relating to a content item and being presented in relation to a visual representation of the content item in a user interface;
receiving content identification information for a first plurality of content items with which the first visual stamp object is associated; and
presenting the content identification information.
